(19) United States
(12) Patent Application Publication
(10) Pub. No.: US 2013/0218310 A1
(43) Pub. Date: Aug. 22, 2013

(54) COMPUTER-IMPLEMENTED ATHLETE DEVELOPMENT SYSTEM AND METHODS THEREOF

(71) Applicant: ROBERT JOHNSON, Chester, NJ (US)

(72) Inventor: ROBERT JOHNSON, Chester, NJ (US)

(21) Appl. No.: 13/772,274

(22) Filed: Feb. 20, 2013

Related U.S. Application Data
(60) Provisional application No. 61/600,918, filed on Feb. 20, 2012.

(51) Int. Cl. G06F 17/00

(52) U.S. Cl. CPC G06F 17/60
USPC 700/91

(57) ABSTRACT

In one embodiment of the present invention, a computer-implemented method for utilizing an athlete development system, the method comprises receiving an application to access the system from an athlete and storing the application in an athlete database; conducting an athlete evaluation, the athlete evaluation comprising at least one of a mental skills assessment of the athlete, an assessment of past performance of the athlete, or an evaluation of the marketability of the athlete; allowing an administrator to grant access to the system to the athlete based on the results of the athlete evaluation and the application; enabling a mentoring module for the athlete, the mentoring module comprising at least one of mental skill mentoring or life coach mentoring; and enabling a fan base forum module adapted to enable a fan to engage the athlete within the system.

### CROSS-REFERENCE TO RELATED APPLICATIONS

The present application claims priority to U.S. Provisional Patent Application Ser. No. 61/600,918 entitled “Computer-Implemented Athlete Development System and Methods Thereof,” filed Feb. 20, 2012, the disclosure of which is incorporated herein by reference in its entirety.

### BACKGROUND OF THE INVENTION

1. Field of the Invention

Embodiments of the present invention generally relate to a computer-implemented athlete development system and methods thereof. More specifically, embodiments of the present invention relate to a computer-based network designed to assist highly-skilled athletes who have not yet reached their full potential with exposure to necessary amenities and services often difficult to acquire as an professional, amateur or young athlete, such as a diverse fan base, professional sport mental skills training, stress management, life coach mentoring, sport mental skills assessments either computerized or paper forms, interviews and educational sport psychological counseling and financial assistance.

2. Description of Related Art

In order to attain professional status, many amateur athletes require significant financial resources and access to mentoring and advice from various professionals. Many current professional athletes would not have become successful without access to these resources. Unfortunately, there are many more individuals that possess the raw physical and mental capability required of professional athletes, but never attain professional status because they lack the financial resources and access to mentoring required to get to the next level. Many of these individuals have immense talent, but are forced to give up their respective sports because they have no means to attain the financial resources and access to mentors that would take them to the professional level. If the family members or personal friends of these individuals are not able to assist them with financial or mentoring resources, many of these individuals have no other means of obtaining the financial and mentoring resources they need to gain success. Even if a potential sponsor exists for these players, the athletes have no means of finding these sponsors and the sponsors have no means of finding the athletes. The same holds true if a fan or a group of fans desires to sponsor an athlete of limited resources. The parties have no way to locate or contact each other and there exists no means of facilitating athlete development.

Thus, there is a need for a computer-implemented athlete development system and methods thereof for providing athletes the resources they need to become successful.

### SUMMARY

Embodiments of the present invention generally relate to a computer-implemented athlete development system and methods thereof. In one embodiment, A computer-implemented method for utilizing an athlete development system, the method comprising: at a computing device hosted by an administrator, the computing device having a processor and a memory for storing a set of instructions for execution by the processor, the instructions for enabling a method comprising: receiving an application to access the system from an athlete and storing the application in an athlete database; conducting an athlete evaluation, the athlete evaluation comprising at least one of a mental skills assessment of the athlete, an assessment of past performance of the athlete, or an evaluation of the marketability of the athlete; allowing an administrator to grant access to the system to the athlete based on the results of the athlete evaluation and the application; enabling a mentoring module for the athlete, the mentoring module comprising at least one of mental skill mentoring or life coach mentoring; and enabling a fan base forum module adapted to enable a fan to engage the athlete within the system.

In another embodiment of the present disclosure, a computer-implemented method for utilizing an athlete development system, the method comprising: at a computing device hosted by an administrator, the computing device having a processor and a memory for storing a set of instructions for execution by the processor, the instructions for enabling a method comprising: receiving an application to access the system from an athlete and storing the application in an athlete database; conducting an athlete evaluation, the athlete evaluation comprising at least one of a mental skills assessment of the athlete, an assessment of past performance of the athlete, or an evaluation of the marketability of the athlete; allowing an administrator to grant access to the system to the athlete based on the results of the athlete evaluation and the application; enabling a mentoring module for the athlete, the mentoring module comprising at least one of mental skill mentoring or life coach mentoring; enabling a fan base forum module adapted to enable a fan to engage the athlete within the system; and enabling the administrator to designate a status level to the fan, the status level comprising at least a general status and a preferred status; wherein the fan forum module may be adapted to allow a fan with general status to access general information about the athlete, to allow a fan with preferred status to communicate directly with the athlete via the system.

In yet another embodiment of the present disclosure, a computer-implemented athlete fan forum module comprises: at a computing device hosted by an administrator, the computing device having a processor and a memory for storing a set of instructions for execution by the processor, the instructions for enabling a method comprising: allowing the administrator to grant access to a system to an athlete; enabling a fan base forum module adapted to enable a fan to engage the athlete within the system; and enabling the administrator to designate a status level to the fan, the status level comprising at least a general status and a preferred status; wherein the fan forum module may be adapted to allow a fan with general status to access general information about the athlete, to allow a fan with preferred status to communicate directly with the athlete via the system; and wherein the fan forum module may be adapted to allow a fan to engage with an athlete if the fan has paid a subscription fee.

### BRIEF DESCRIPTION OF THE DRAWINGS

So the manner in which the above recited features of the present invention can be understood in detail, a more particular description of embodiments of the present invention, briefly summarized above, may be had by reference to embodiments, which are illustrated in the appended drawings. It is to be noted, however, the appended drawings illustrate only typical embodiments of embodiments encompassed within the scope of the present invention, and, therefore, are not to be considered limiting, for the present invention may admit to other equally effective embodiments, wherein:

FIG. 1 depicts a system-level network diagram of a computer-implemented athlete development system in accordance with one embodiment of the present disclosure;

FIG. 2 depicts a block diagram of a general computer system in accordance with one embodiment of the present disclosure;

FIG. 3 depicts a block diagram of an athlete development system in accordance with embodiments of the present disclosure;

FIG. 4 depicts a block diagram of an evaluation module in accordance with embodiments of the present disclosure;

FIG. 5 depicts a block diagram of a mentoring module in accordance with embodiments of the present disclosure;

FIG. 6 depicts a user interface in accordance with embodiments of the present disclosure; and

FIG. 7 depicts a flowchart of a method of utilizing the computer-implemented athlete development program in accordance with one exemplary embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

Embodiments of the present invention generally relate to a computer-implemented athlete development system and methods thereof. More specifically, embodiments of the present invention relate to a computer-based network designed to assist highly-skilled athletes who have not yet reached their full potential with exposure to necessary amenities and services often difficult to acquire as a professional, amateur or young athlete, such as a diverse/global fan base, professional sport mental skills training, stress management, life coach mentoring, sport mental skills assessments either computerized or paper forms, interviews and educational sport psychological counseling and financial assistance.

In the following detailed description, numerous specific details are set forth in order to provide a thorough understanding of exemplary embodiments or other examples described herein. However, it will be understood that these examples may be practiced without the specific details. In other instances, well-known methods, procedures, components and circuits have not been described in detail, so as to not obscure the following description. Further, the examples disclosed herein are for exemplary purposes only and other examples may be employed in lieu of, or in combination with, the examples disclosed. It should also be noted that the examples presented herein should not be construed as limiting of the scope of embodiments of the present invention, as other equally effective examples are possible and likely.

As used herein, the term “multimedia data” refers to any type of data that may reasonably be construed as a media data type, including specifically, audio data (e.g., sound bites, music, or the like), visual data (e.g., photographs, images, graphics, videos, or the like), text data (e.g., as entered by a user from an input device or generated by a computing device), digital files, barcode data (e.g., as commonly found on tickets, labels, or the like), radio frequency identification (RFID) data, Quick Response (QR) tags, geographic and/or directional data (e.g., as reported from a Global Positioning System (GPS), a mobile communications system, or a preprogrammed routing source, often in the form of coordinates, or relationship positioning), or the like. As understood by the embodiments disclosed herein, any discussion of one particular form of multimedia data or data, shall be inclusive of any other type of multimedia data as defined above.

As used herein, the term “athlete,” or variations thereof, shall include any professional, Olympic, amateur, collegiate, junior, nationally or world-raked, high school, or similarly situated individual who participates in a competitive event against others, either directly or by virtue of a scoring system, whereby further training, focus, skill development or the like, may enhance the likelihood of success for the individual to compete on a higher level of performance. In addition, for purposes of embodiments of the present invention, the term “athlete” should be deemed inclusive of other skilled persons, such as musicians, performing artists, or the like, such that any of such persons who must perform on an enhanced level may benefit from embodiments of the present invention.

In accordance with certain embodiments of the present invention, methods disclosed herein may occur in “real-time.” Real-time is utilized herein as meaning near-instantaneous, subject to minor delays caused by network transmission and computer processing functions, and able to support various input and output data streams.

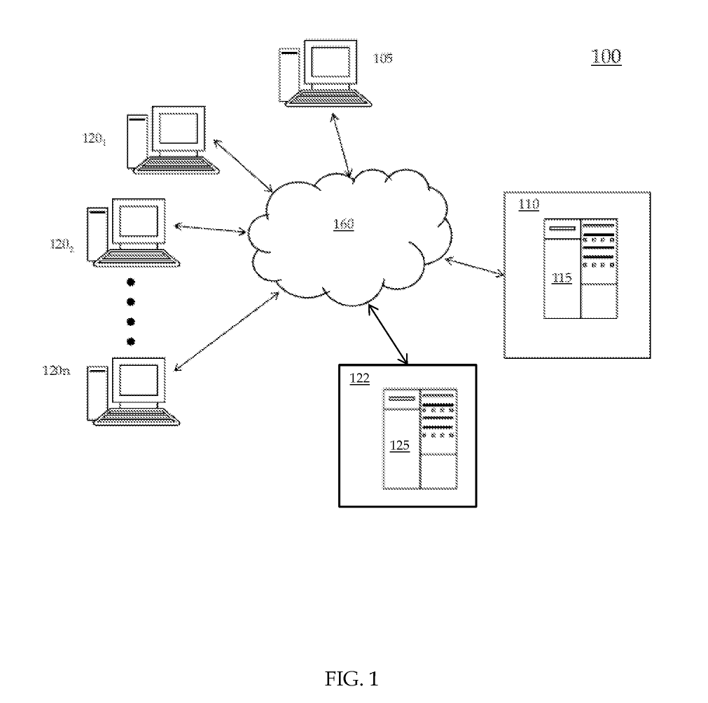

FIG. 1 depicts a system-level network diagram of a computer-implemented athlete development system in accordance with one embodiment of the present invention. The system 100 generally comprises at least a first user 105 and secondary users 120₁ and 120₂, each in communication with an administrator 110, generally hosting a central server 115 or database, through a network 160, which may comprise a global computer network, for example, the Internet.

As is common in network-based business models, the administrator 110 may also comprise a web administrator, responsible for providing and maintaining a website or interactive portal through which all of the users of the system 100 may interact and execute the methodology and functionality disclosed in the embodiments disclosed herein.

Although FIG. 1 explicitly depicts three secondary users 120₁, 120₂, and 120ₙ, it should be appreciated that “n” represents any number of users feasible in accordance with embodiments of the present disclosure. For ease of reference, as used herein, each of the terms “second user” or “secondary user” may refer to any one or all of the users 120₁, 120₂, and 120ₙ within the computer system 100. Likewise, although FIG. 1 explicitly depicts only one first user 105, there may be more than one first user 105 in accordance with certain embodiments of the present disclosure. That is, in certain embodiments, multiple users may perform the same or similar functions as the first user 105. As understood by embodiments of the present disclosure, a user may include any person, business, organization, group, or other entity, capable of participating in the system and methods disclosed herein.

In many embodiments, the first user 105 may comprise an athlete seeking to enhance a mental and/or psychological skill set regarding performance for a particular sport and/or competition. The skill set may be a physical skill set (e.g., involving hand-eye coordination), a mental skill set (e.g., involving concentration or focus on a task at hand), a financial skill set (e.g., the ability for the athlete to pay his/her bills while focusing on athletic performance), a moral skill set (e.g., regarding the athlete's self-esteem, commitment self-confidence, etc.), or the like.

The secondary users 120 may generally comprise all other individuals, businesses, etc., that are part of the system 100. In many embodiments, the secondary users 120 comprise one of a sport psychologist, a personal mentor, a life coach, a trainer, a conditioning coach, a skill coach, a manager, a sports agent, a physician, a fan, a sponsor, an objective observer (e.g., a media affiliate), or the like. Generally, the secondary user 120 has an interest in the first user 105. In many embodiments, the interest may comprise a financial interest (e.g., from an investment or advertising perspective), a supportive interest (e.g., a fan rooting for a favorite athlete), a philanthropic interest (e.g., a donor seeking to encourage an aspiring athlete by providing fiscal stability), a newsworthy interest (e.g., where the athlete shows the potential of being a superstar), or the like.

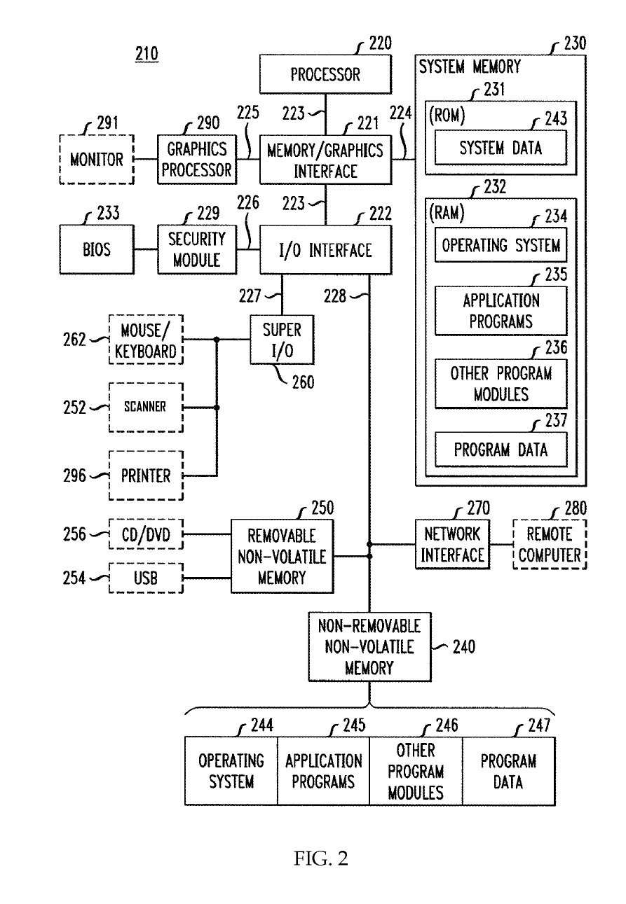

In a basic exemplary embodiment, within the system 100, a first user 105 and second user 120 may be capable of transmitting data, including multi-media data, to the administrator 110, using a mobile device. The mobile device in the context of this application may include, but is not limited to a smartphone, an Apple iPhone, a Blackberry device, Personal Data Assistant (PDA), a netbook, a mobile computer or the like, or may generally include a general purpose computer or components thereof, whether mobile or not, as discussed below in FIG. 2.

As explained above, the network 160 may comprise any network suitable for embodiments of the present disclosure. For example, the network 160 may be a partial or full deployment of most any communication/computer network or link, including any of, any multiple of, any combination of or any combination of multiples of a public or private, terrestrial wireless or satellite, and wireline networks or links. The network 160 may include, for example, network elements from a Public Switch Telephone Network (PSTN), the Internet, core and proprietary public networks, wireless voice and packet-data networks, such as 1G, 2G, 2.5G, 3G, 4G, and 5G telecommunication networks, wireless office telephone systems (WOTS), Global Systems for Mobile communications (GSM), General Packet Radio Service (GPRS) systems, Enhanced Data GSM Environments (EDGE), and/or wireless local area networks (WLANs), including, Bluetooth and/or IEEE 802.11 WLANs, wireless personal area networks (WPANs), wireless metropolitan area networks (WMANs) and the like; and/or communication links, such as Universal Serial Bus (USB) links; parallel port links, Firewire links, RS-232 links, RS-485 links, Controller-Area Network (CAN) links, and the like.

Optionally, a third party 122, generally hosting a server 125, database, non-commercial server, or the like, may be in communication with the computer system 100 through the network 160 to carry out certain features of embodiments of the present disclosure, as explained below. In accordance with embodiments of the present disclosure, such third party servers 125 may be administered by financial institutions (e.g., banks, credit card companies, or the like), advertisers (e.g., any third party offering banner ads or displayed offers), local merchants (e.g., providing information regarding an area or services within an area) social networking sites (e.g., Facebook, MySpace, Twitter, FourSquare or the like), global positioning system administrators, or the like.

In accordance with one embodiment of the present disclosure, any of the administrator or users may comprise a general purpose computer, for example, as shown in the form of a computer 210 depicted in FIG. 2. As appreciated by embodiments of the present disclosure, more practical devices, such as mobile devices, mobile telephones, laptop computers, netbooks, tablet computers, or the like, are likely to be utilized than a general computer 210 for embodiments of the present disclosure. However, it is also appreciated there is a significant similarly in core components between a mobile device, a personal computer, and a general computer 210. The following components are described for exemplary purposes only, and each component's mobile equivalent is also contemplated within embodiments of the present disclosure.

Components shown in dashed outline are not part of the computer 210, but are used to illustrate the exemplary embodiment of FIG. 2. Components of computer 210 may include, but are not limited to, a processor 220, a system memory 230, a memory/graphics interface 221, also known as a Northbridge chip, and an I/O interface 222, also known as a Southbridge chip. The system memory 230 and a graphics processor 290 may be coupled to the memory/graphics interface 221. A monitor 291 or other graphic output device may be coupled to the graphics processor 290.

A series of system busses may couple various system components including a high speed system bus 223 between the processor 220, the memory/graphics interface 221 and the I/O interface 222, a front-side bus 224 between the memory/graphics interface 221 and the system memory 230, and an advanced graphics processing (AGP) bus 225 between the memory/graphics interface 221 and the graphics processor 290. The system bus 223 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the Hypertransport architecture, respectively.

The computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 210. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. The system ROM 231 may contain permanent system data 243, such as identifying and manufacturing information. In some embodiments, a basic input/output system (BIOS) may also be stored in system ROM 231. RAM 232 typically contains data and/or program modules that are immediately accessible to and/or presently being operated on by processor 220. By way of example, and not limitation, FIG. 2 illustrates operating system 234, application programs 235, other program modules 236, and program data 237.

The I/O interface 222 may couple the system bus 223 with a number of other busses 226, 227 and 228 that couple a variety of internal and external devices to the computer 210. A serial peripheral interface (SPI) bus 226 may connect to a basic input/output system (BIOS) memory 233 containing the basic routines that help to transfer information between elements within computer 210, such as during start-up.

In some embodiments, a security module 229 may be incorporated to manage metering, billing, and enforcement of policies. The security module 229 may comprise any known security technology suitable for embodiments disclosed herein.

A super input/output chip 260 may be used to connect to a number of peripherals, such as scanner 252, keyboard/mouse 262, and printer 296, as examples. The super I/O chip 260 may be connected to the I/O interface 222 with a low pin count (LPC) bus, in some embodiments. The super I/O chip 260 is widely available in the commercial marketplace.

In one embodiment, bus 228 may be a Peripheral Component Interconnect (PCI) bus, or a variation thereof, may be used to connect higher speed peripherals to the I/O interface 222. A PCI bus may also be known as a Mezzanine bus. Variations of the PCI bus include the Peripheral Component Interconnect-Express (PCI-E) and the Peripheral Component Interconnect-Extended (PCI-X) busses, the former having a serial interface and the latter being a backward compatible parallel interface. In other embodiments, bus 228 may be an advanced technology attachment (ATA) bus, in the form of a serial ATA bus (SATA) or parallel ATA (PATA).

The computer 210 may also include other removable/non-removable, volatile/nonvolatile computer storage media. By way of example only, FIG. 2 illustrates a hard disk drive 240 that reads from or writes to non-removable, nonvolatile magnetic media. Removable media, such as a universal serial bus (USB) memory 254 or CD/DVD drive 256 may be connected to the PCI bus 228 directly or through an interface 250. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media discussed above and illustrated in FIG. 2, provide storage of computer readable instructions, data structures, program modules and other data for the computer 210. In FIG. 2, for example, hard disk drive 240 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 210 through input devices such as a mouse/keyboard 262 or other input device combination. Other input devices (not shown) may include a microphone, joystick, game pad, satellite dish, touch screen, fax machine, modem, touch pad, or the like. These and other input devices are often connected to the processor 220 through one of the I/O interface busses, such as the SPI 226, the LPC 227, or the PCI 228, but other busses may be used. In some embodiments, other devices may be coupled to parallel ports, infrared interfaces, game ports, and the like (not depicted), via the super I/O chip 260.

The computer 210 may operate in a networked environment using logical connections to one or more remote computers, such as a remote computer 280 via a network interface controller (NIC) 270. The remote computer 280 may be a personal computer, a server, a router, a network PC, a peer device or other common network node, and typically includes many or all of the elements described above relative to the computer 210. The logical connection between the NIC 270 and the remote computer 280 depicted in FIG. 2 may include a local area network (LAN), a wide area network (WAN), or both, but may also include other networks. Such networking environments are commonplace in offices, enterprise-wide computer networks, intranets, and the Internet.

In some embodiments, the network interface may use a modem (not depicted) when a broadband connection is not available or is not used. It will be appreciated that the network connection shown is exemplary and other means of establishing a communications link between the computers may be used.

Although the computer 210 of FIG. 2 is described as an exemplary computing device for various applications of embodiments of the present disclosure, it should be appreciated, a multitude of similar computing devices exist and are equally suitable for embodiments of the present disclosure. It is further understood by embodiments of the present disclosure, a computing device may comprise all of the elements disclosed in FIG. 2, or any combination of one or more of such elements, in order to perform the necessary functions of the embodiments of the present disclosure. Further, but other commonly known, components for mobile devices and personal computers may also be included in a general computer 210. For example, global positioning chips, wireless communication capability, and related technologies should be included within many embodiments of the present disclosure.

It is understood by embodiments of the present disclosure that a computer, such as the one depicted in FIG. 2, may be connected to a computer network or system. A computer network may include the Internet, a global computer network, a global positioning system, an internal computer network, dedicated server networks, or the like.

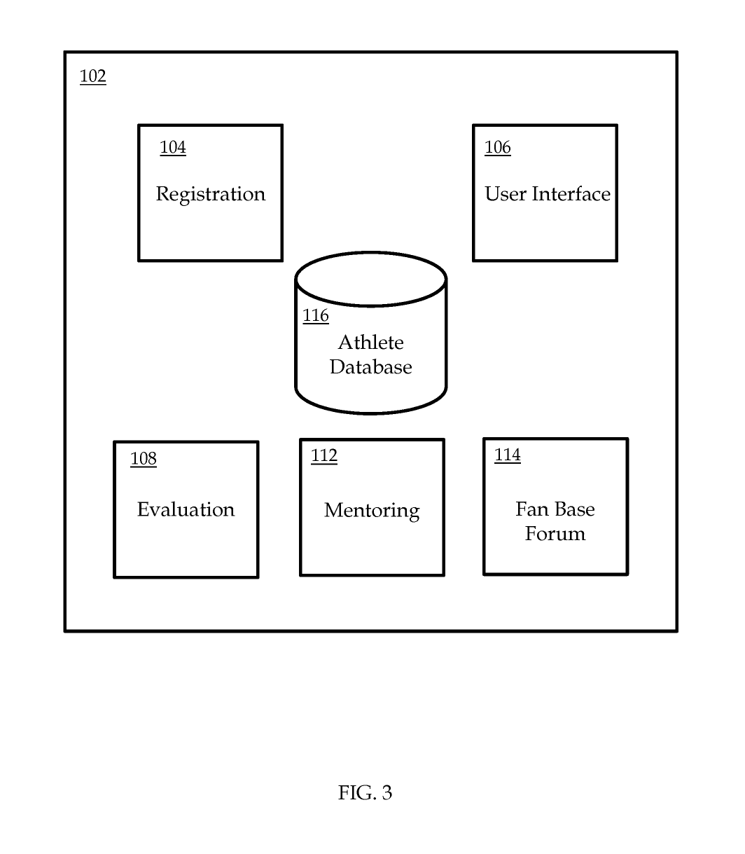

FIG. 3 depicts a block diagram of an athlete development system 102 in accordance with embodiments of the present disclosure. The athlete development system 102 may generally comprise computer executable software and/or instructions configured to perform the functionality of the systems and methods disclosed herein. In exemplary embodiments, the athlete development system 102 may comprise a registration module 104, a user interface module 106, an evaluation module 108, a mentoring module 112, a fan base forum 114, and an athlete database 116. Each of the modules described herein may comprise additional computer executable software and/or instructions configured to perform a set of tasks. In some embodiments, multiple modules may be combined into a single module, and functions performed by one module may be performed by other modules. The athlete development system 102 may generally configured to assist highly-skilled athletes who have not yet reached their full potential with exposure to necessary amenities and services often difficult to acquire as an professional, amateur or young athlete, such as a diverse fan base, professional sport mental skills training, stress management, life coach mentoring, sport mental skills assessments either computerized or paper forms, interviews and educational sport psychological counseling and financial assistance. For embodiments where the athlete comprises a musician, performing artist, or the like, similar types of amenities and services may be necessary for such musicians or artists to achieve their full potential and reach the pinnacle of their careers.

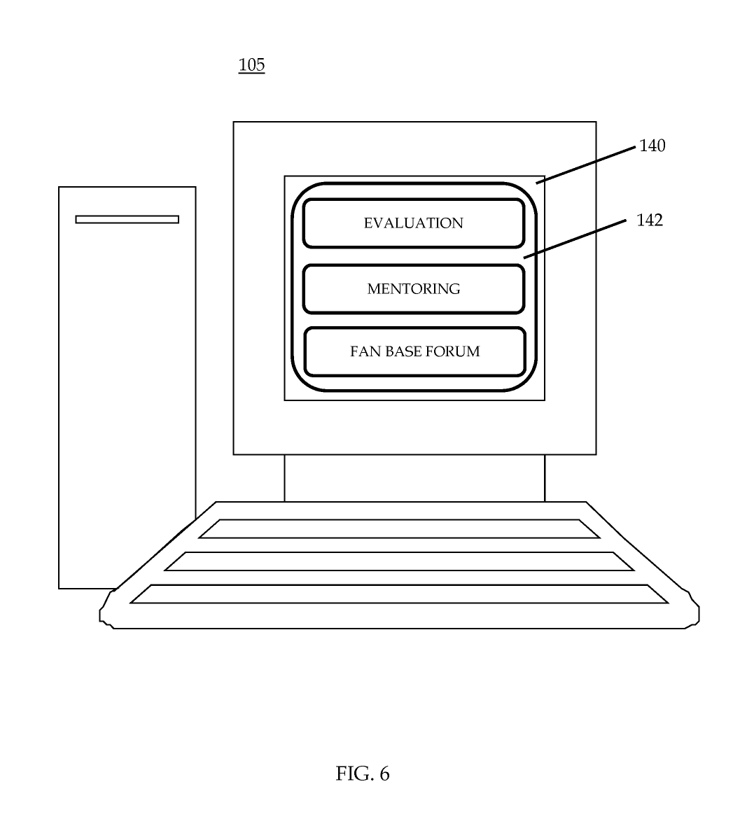

The user interface module 106 may be adapted to allow a user to access the athlete development system 102 via a user interface. The user interface module 106 may be adapted to allow a user to view output of the system 102, to enter data in the system 102, to configure the functionally or views of the system 102, to print portions of the system 102 and/or additional functionality in accordance with embodiments of the present disclosure. In exemplary embodiments, a user interface may be adapted to display a graphical representation of a portion of the system 102. The user interface may comprise a look and feel that is comfortable for the user and user-friendly. The appearance and functionality of the user interface may generally be configured by an administrator or may be preconfigured. An example of a user interface may be seen in FIG. 6, described below.

The registration module 104 may be optional, and may be adapted to receive registration data and generate user accounts. User accounts may be granted access the various aspects of the system 102. Different types of user accounts may be assigned different capabilities, security permissions, and/or access to different functions of the system 102. For example, the registration module 104 may be adapted to create user accounts for administrators, athletes, fans, athlete evaluators, and/or athlete mentors, with each type of account having a different set of security permissions and access to different modules or portions of modules in the system 102. Any user may access the registration module 104 to request an account and initiate the registration process to create a user account.

During the registration process, the registration module 104 may be adapted to receive information about the athlete and/or user, and the type of account requested. Such information may be received in response to inquiries provided to the user by the system 102. The user may be provided an area to enter text responses to inquiries or may be provided a list of options to select, for example with a drop-down menu, radio buttons, a selectable graphic or icon, and/or the like. In some embodiments, the athlete will be allowed to enter requested general information and assessment data before gaining access to additional modules of the system 102, such as the mentoring module 112 and/or the fan base forum module 114.

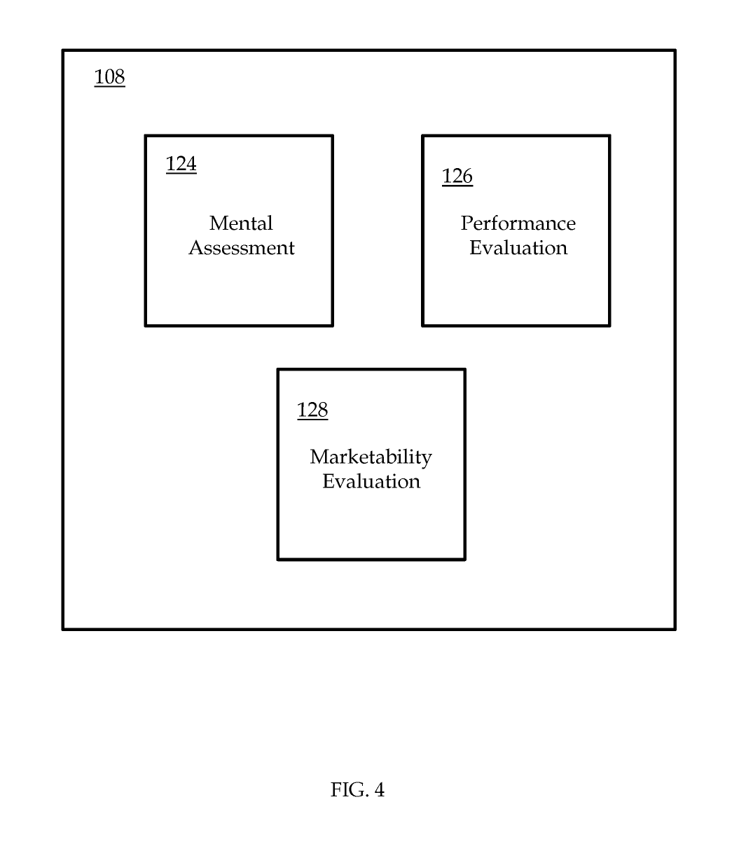

In some embodiments, the registration module 104 may be adapted to receive information from an athlete and provide it to an administrator for evaluation and acceptance determination. For example, the administrator may be provided with an athlete's biography and/or an application to join the system. In some embodiments, an administrator and a mentor may comprise the same entity or may comprise different entities or different groups of entities. In many embodiments, the biography/application may comprise a listing of relevant information to the athlete's information as a potential member of the system. Once the athlete's biography and/or application is received and reviewed by an administrator, if there is sufficient desirable information thereon, the administrator may conduct a sport mental skills assessment by using the evaluation module 108, generally described below with respect to FIG. 4. The registration module 104 may be configured to store the data received during the registration process in an athlete database 114 or other sortable data storage memory adapted to enable the systems and methods disclosed herein.

The athlete database 114 may generally comprise any data storage database suitable for embodiments of the present disclosure. For example, in one embodiment, the athlete database 114 may comprise at least one or more database management systems, such as any of an Oracle, DB2, Microsoft Access, Microsoft SQL Server, Postgres, MySQL, 4th Dimension, FileMaker, Alpha Five, or the like. The athlete database 114 may be adapted to store data received by the system 102. Data stored in the athlete database 114 may generally be accessed by any module described herein. In some embodiments, each module may be configured with specific security permissions, for example, read, write, execute, delete, and/or the like.

FIG. 4 depicts a block diagram of an evaluation module 108 in accordance with embodiments of the present disclosure. The evaluation module 108 may generally be adapted to collect data for the purposes of assessing the capabilities, both mental and physical, of an athlete requesting access to the system. The evaluation module 108 may generally comprise a mental assessment sub-module 124, a performance evaluation sub-module 126, and/or a marketability evaluation sub-module 128.

In exemplary embodiments, the mental assessment sub-module 124 may be adapted to facilitate and/or provide an assessment of an athlete's mental capabilities and potential for becoming a professional in a sport or other art form. In some embodiments, mental assessment sub-module 124 may be adapted to allow the administrator to work with a third party, such as a sport psychologist, and evaluate the sport mental skills of an athlete. In one embodiment, the sport mental skills assessment provided by the mental assessment sub-module 124 comprises a computerized testing procedure, for example, using “The Attentional and Interpersonal Style” (TAIS) Inventory, or similar test, for ascertaining an athlete's awareness, information processing, control, self-confidence, competitiveness, decision making ability, extroversion vs. introversion, performance under pressure, focus over time, and the like. While TAIS may be used in many embodiments, any type of sport mental skill assessment test, survey or analysis may be utilized either computerized, paper or interview. The mental assessment sub-module 124 may be adapted to provide an assessment test through a user interface, and/or the results of an assessment test may be entered, scanned, or imported into the system 102.

In addition to the computerized testing procedure, in many embodiments, mental assessment sub-module 124 may be adapted to facilitate and/or provide a mental skills performance and/or clinical interview or similar non-testing evaluation to ascertain the mental skills of the athlete. In one embodiment, a physical interview with a professional may be conducted and scheduled by the mental assessment sub-module 124. The results of such an assessment may be scored with a scoring system, or may be provided in raw form to the administrator by the mental assessment sub-module. In another embodiment, a web-based conversation, such as a video chat, may be held via the mental assessment sub-module 124 whereby the administrator and/or its staff/consultants, may be able to watch visible responses when the athlete is answering questions or providing certain information. In further embodiments, any additional data acquisition means (e.g., written, telephonic, audio/visual, etc.) may be used to conduct a sport mental skills assessment.

In exemplary embodiments, the performance evaluation sub-module 126 may generally be adapted to facilitate and/or provide an assessment of an athlete's physical capabilities, talents, and record of playing a particular sport or participating in a particular art form. The performance evaluation sub-module 126 may be adapted to allow an administrator to evaluate the past performance of the athlete to determine if the athlete has demonstrated sufficient physical skills, or the potential thereof, to qualify for the system 102. In many embodiments, the administrator may review a stored set of data in the athlete database 116, indicating performance characteristics of the athlete. For example, in one embodiment, the performance evaluation sub-module 126 may be adapted to allow the administrator to consider past finishing positions, final scores/results, performance trends, performance under pressure, or the like. In some embodiments, the information considered is in the form of statistician data—i.e., for example, correlations between certain conditions (e.g., weather, health, quality of competition, etc.) and the athlete's performance. In other embodiments, the administrator may consider third party reports, such as news articles or the like, regarding the athlete's performance and other generally useful factors, such as perception, attitude, frustration, etc., which may not be readily ascertainable from data alone.

In exemplary embodiments, the marketability evaluation sub-module 128 may be configured to facilitate and/or provide an evaluation of the marketing appeal the athlete may have to supporters and fans of a particular sport or art form. The marketability evaluation sub-module 128 may be adapted to allow an administrator to consider the marketability of the athlete. In many embodiments, the marketability of the athlete is determined by an evaluation of the athlete's affiliations, unique characteristics, or the like. Whereas marketing often involves public opinion, in certain embodiments, the marketability evaluation sub-module 128 may be adapted to allow an administrator to access third party surveys, objective analysis, and other forms of market test data may be acquired to determine whether an athlete will have sufficient marketability for the system.

In exemplary embodiments, after the administrator has utilized the evaluation module 108 and its sub-modules 124, 126, 128 or the like, the administrator may determine whether the athlete may be accepted into the system 102. Acceptance of an athlete may be determined by the decision of an individual administrator, a team of administrators, or an algorithm that assigns weighted values to each of the athlete's characteristics and determines if the total of the weighted values surpasses a threshold configured by one or more administrators. In some embodiments, an administrator may accept recommendations from consultants or other third parties who have reviewed the athlete's data.

Once an athlete is accepted into the system 102, the athlete may become a system player, such that the athlete is designated and held out to the public as being affiliated with the administrator. In such an embodiment, the administrator effectively becomes a sponsor of the athlete, but beyond mere financial sponsorship, the athlete may be fully committed to the administrator from an across-the-board perspective. In other embodiments, acceptance into the system indicates that the administrator will offer the athlete a job as a contract employee, whereby the administrator will agree to provide certain compensation and benefits, as described herein, in exchange for the athlete's performance, appearances, behavior and the like. Once in the system, the athlete may be granted access to a mentoring module 112 and/or exposed to numerous professionals to enable the athlete to reach a maximum skill potential.

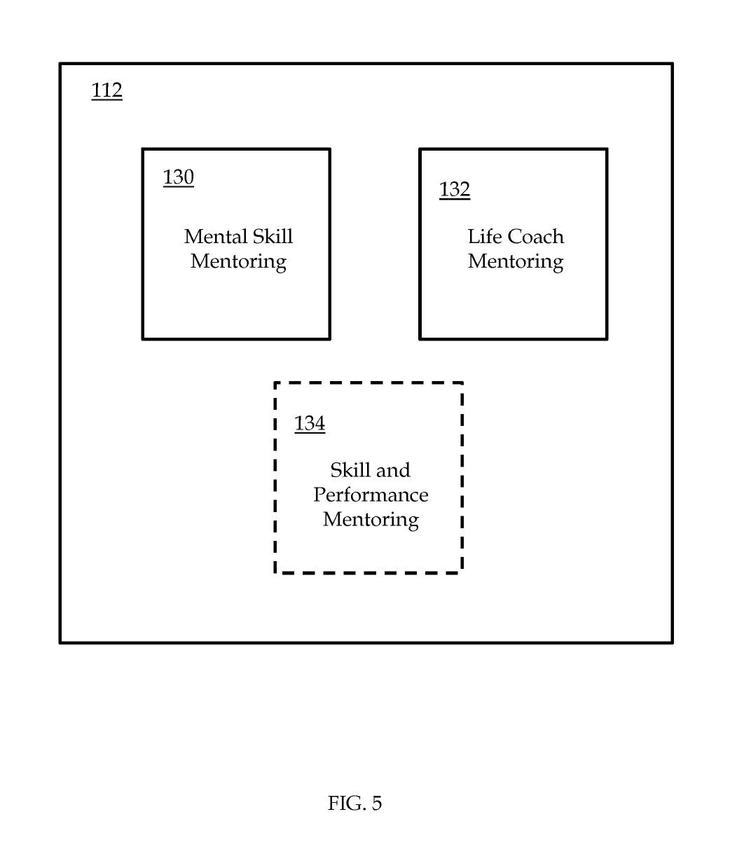

FIG. 5 depicts a block diagram of a mentoring module 112 in accordance with embodiments of the present disclosure. A mentoring module 112 may generally be adapted to provide mentoring to an athlete that is approved for access to the system by after evaluation is performed by the evaluation module 108. The mentoring module 112 may be adapted to provide mentoring services, such as mental, physical, and/or financial education, coaching, counseling, and/or support to the athlete. In some embodiments mentoring services may be provided by the mentoring module 112 in the form of content delivered to the athlete. For example, one or a combination of text, audio, image, and/or video content related to mentoring may be provided to the athlete on-demand or as part of a structured class or program.

In some embodiments, the mentoring services may be provided to the user via direct communication between and athlete and a mentor. For example, the mentoring module 112 may be configured to facilitate direct communication between an athlete and a mentor. For example, the mentoring module 112 may be adapted to facilitate communications via text, video, and/or voice communications through a user interface of the system 102. The mentoring module 112 may also be adapted to facilitate real time chats, such as video chats, text chats, audio chats, or the like between a mentor and an athlete. In some embodiments, the system 102 may be configured to allow communication between different users or groups of users. For example, two or more mentors may communicate with each other or simultaneously with an athlete. In addition to virtual communication, the mentoring module 112 may be adapted to facilitate face-to-face or in-person meetings between one or more athletes, mentors, or the like by allowing users to schedule times for meetings and to view the meeting availability of other users. The mentoring module 112 may generally comprise a mental skill mentoring sub-module 130, a life coach mentoring sub-module 132, and/or a skill and performance mentoring sub-module 134.

The mental skill mentoring sub-module 130 may be adapted to provide mentoring and/or coaching for the mental capabilities required of a professional athlete. In many embodiments, a reason why the athlete is not playing to the maximum potential is due to personal distractions, issues with focus, or the like. The mental skill mentoring sub-module 130 may be adapted to facilitate and schedule virtual or in-person meetings with a mental skills professional, such as a sport mental skills professional on an ongoing and/or regular basis. In many embodiments, mental skills professional may provide the athlete the opportunity to discuss certain issues, concerns, etc. In other embodiments, the mental skill mentoring sub-module 130 may be adapted to provide the athlete an opportunity to learn and/or practice certain drills to learn to maintain proper focus during physical performance. In yet further embodiments, the athlete may just need to check in and have a brief conversation with a mental skills professional from time to time. The mental skill mentoring sub-module 130 may adapted to enable this check in process.

The life coach mentoring sub-module 132 may be adapted to provide life skill mentoring, such as budgeting, investing, time management, people management, or the like. The athlete may access the life coach mentoring sub-module 132 to engage in life coach mentoring. In many embodiments, the athlete's personal issues interfere with the athlete's ability to perform at its best on a regular basis. As such, in many embodiments, life coach mentoring sub-module 132 may be adapted to allow the athlete to communicate with a life coach/mentor who can advise the athlete how to resolve or handle such issues. In other embodiments, life coach mentoring sub-module 132 may be adapted to allow the life coach/mentor to be able to assist the athlete by providing the athlete a plausible path to attain whatever is needed to lessen the external distractions (e.g., find financial assistance, get spouse in counseling, just listen to the athlete vent about personal problems, etc.)

The skill and performance mentoring sub-module 134 may be configured to provide training for the physical skills required of a professional athlete, and may be optional. The skill and performance mentoring sub-module 134 may be adapted to allow an athlete to optionally engage in skill and/or performance mentoring. In many embodiments, skill and performance mentoring sub-module 134 may be adapted to allow skill coaches to advise and guide the athlete to increase the athlete's physical performance. In many embodiments, the skill or performance mentoring is conducted by a professional in the particular athletic field, and/or has experience in general strength and/or conditioning training. In further embodiments, skill and performance mentoring sub-module 134 may be adapted to allow general trainers, such as physical therapists, massage therapists, conditioning trainers, biomechanics coaches or the like to communicate with and coach/train the athlete.

Referring back to FIG. 3, the mentoring system 102 may also be configured to provide a fan base forum module 114. The fan base forum module 114 may be configured to allow fans authorized to use the system 102 access to athletes sponsored by the fans. The access levels of fans may vary based on different criteria. For example a donation level or a loyalty time may be required for different levels of access to an athlete. In many embodiments, fan base forum module 114 is adapted to generate a fan base forum comprising a social media network, wherein the administrator enables fans (i.e., any of the secondary users described herein), to directly and indirectly engage the athlete within the system and effectively, power the system's operation. In one exemplary embodiment, fan base forum module 114 may be adapted to allow the administrator to establish a social media page, or “storefront” for each of the athletes within the system, and host the page or storefront on a sever accessible via a network. In order for a fan to access the system, and in particular, a storefront for an athlete, the fan may be required to become an authorized fan of the system. In many embodiments, such authorization comes by way of subscribing to the system, establishing an account and paying an access fee.

In accordance with several embodiments, a fan of the system may have to select a position to which the fan wishes to be designated when subscribing to the system. Such position may comprise a platform or tier within a hierarchy system, and may often be connected to the value of compensation paid by the fan to access the system. In some embodiments, the fan base forum module 114 may allow the fan platform or tier within the system to designate the level of accessibility the fan may have within the system. One objective of the fan base forum is to provide a virtual means by which a fan of an athlete can follow, interact (directly or indirectly), or otherwise exchange data with the athlete. The fan base forum module 114 may be adapted to allow a fan to post comments, pictures, videos, or other data on the athlete's storefront, as well as conduct other social networking features thereon. The fan base forum module 114 may also be adapted to provide a fan access to watch the athlete's performances (live or taped), communicate with the athlete, (through live video chat, web conference calls, or the like), track the athlete's performance statistics, etc.

The fan base forum module 114 may allow certain fans to be passive and others more active. For example, a generic fan may be permitted to read and watch postings on the athlete's storefront, a higher tiered fan may be able to post comments, pictures, and other data on the athlete's storefront, and the highest tiered fans may be invited to communicate directly with the athlete through the live chat means, etc. The fan base forum module 114 may also be adapted to allow an athlete to communicate with fans, as well as receive support, motivation, and other useful data. As such, the positive role played by the fan base forum can assist in creating a more positive outlook in life and in performances, which in turn may assist with overall performance. The fan base forum module 114 and any module described herein may generally be accessed via a user interface.

FIG. 6 depicts a user interface 142 displayed on a display 140 in accordance with embodiments of the present disclosure. The user interface 142 may generally be adapted to provide the user with a means and/or portal to access any system in accordance with the present disclosure, and view information generated by the system on the display 140 of a user 105. The display 140 may comprise two dimensional display, a three dimensional display, a touch screen display, a display that provides haptic feedback, a four dimensional display, a plasma display, a liquid crystal display, or the like. The display 140 may be communicatively coupled with a computing device adapted for use with embodiments of the present disclosure. The user 105 may comprise any entity in accordance with embodiments of the present disclosure. For example, the user 105 may comprise an athlete, a mentor, an administrator, a fan, and/or the like.

The user interface 142 may be adapted to be user friendly, and to comprise customizable menus to allow the user to manipulate the look and feel of the display of data and images generated by the system 102. In addition, the user interface 142 may be adapted to allow a user to run reports, print elements generated by the system, and/or interact with other users through direct messages, message boards, text chats, video chats, instant messaging, blogs, user-generated feeds, or the like. The user interface 142 may also be adapted to display a graphical representation of the system. Although depicted in FIG. 6 as a simple display comprising three options, this is merely for exemplary purposes. Alternative displays, such as menus, icons, animations, or other displays consistent with the present disclosure may also be utilized. In some embodiments, the user interface 142 may display only the portions of the system that a user has security permissions to access. For example, an athlete may be able to access an evaluation and mentoring option, while a fan may only be able to access and/or view a fan base forum.

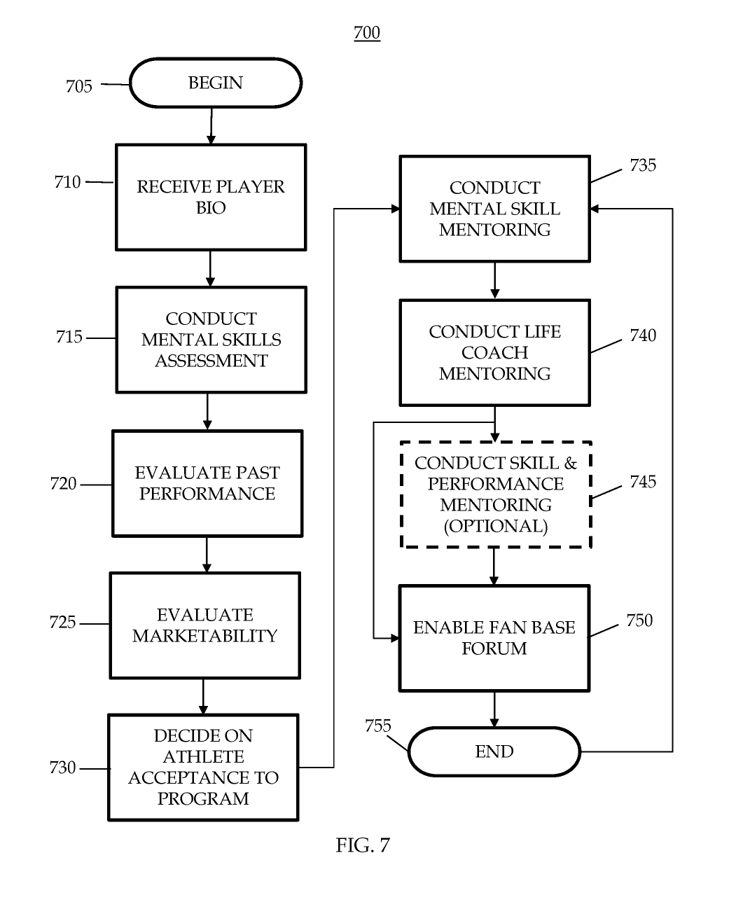

FIG. 7 depicts a flowchart of a method of utilizing the computer-implemented athlete development program in accordance with one exemplary embodiment of the present invention. The method 700 begins at step 705. At step 710, the administrator generally receives an athlete or player's biography and/or application to join the system. In many embodiments, the biography/application comprises a listing of relevant information to the athlete's information as a potential member of the system. For example, a biography may comprise personal information, namely, physical characteristics such as age, weight, height, etc.; performance information, namely past performance results, accolades, etc.; affiliation information, namely, groups, clubs or organization with which the athlete is affiliated (e.g., country clubs, sororities, alumni associations, etc.); unique characteristic information, such as being a unique ethnicity in a particular field, having a disability, etc.; and/or the like.

Once the athlete's biography is received and reviewed, if there is sufficient desirable information thereon, the administrator may conduct a sport mental skills assessment at step 715. In some embodiments, the sport mental skills assessment comprises the administrator working with a sport psychologist, and evaluating the sport mental skills of an athlete. In one embodiment, the sport mental skills assessment comprises a computerized testing procedure, for example, using “The Attentional and Interpersonal Style” (TAIS) Inventory, or similar test, for ascertaining an athlete's awareness, information processing, control, self-confidence, competitiveness, decision making ability, extroversion vs. introversion, performance under pressure, focus over time, and the like. While TAIS may be used in many embodiments, any type of sport mental skill assessment test, survey or analysis may be utilized either computerized, paper or interview.

In addition to the computerized testing procedure, in many embodiments, a mental skills performance and/or clinical interview or similar non-testing evaluation may be conducted to ascertain the mental skills of the athlete. In one embodiment, a physical interview with a professional may be conducted. In another embodiment, a web-based conversation, such as a video chat, may be held whereby the administrator and/or its staff/consultants may be able to watch visible responses when the athlete is answering questions or providing certain information. In further embodiments, any additional data acquisition means (e.g., written, telephonic, audio/visual, etc.) may be used to conduct a sport mental skills assessment.

At step 720, the administrator evaluates the past performance of the athlete to determine if the athlete has demonstrated sufficient physical skills, or the potential thereof, to qualify for the system. In many embodiments, the administrator may review a stored set of data on a computer, indicating performance characteristics of the athlete. For example, in one embodiment, the administrator may consider past finishing positions, final scores/results, performance trends, performance under pressure, or the like. In some embodiments, the information considered is in the form of statistician data—i.e., for example, correlations between certain conditions (e.g., weather, health, quality of competition, etc.) and the athlete's performance. In other embodiments, the administrator may consider third party reports, such as news articles or the like, regarding the athlete's performance and other generally useful factors, such as perception, attitude, frustration, etc., which may not be readily ascertainable from data alone.

At step 725, the administrator considers the marketability of the athlete. In many embodiments, the marketability of the athlete is determined by an evaluation of the athlete's affiliations, unique characteristics, or the like. For example, an athlete with a disability who attended a Division 1A college for a particular sport, and who scored high on the mental skills assessment as being extroverted may have a very high marketability. In another example, a run-of-the-mill athlete who is deemed introverted, and who has no collegiate or social organization with whom she is affiliated may have a low marketability factor. Whereas marketing often involves public opinion, in certain embodiments, third party surveys, objective analysis, and other forms of market test data may be acquired to determine whether an athlete will have sufficient marketability for the system.

At step 730, the administrator decides whether the athlete may be accepted into the system. In many embodiments, when making such a decision, the administrator utilizes a weighted evaluation algorithm, whereby each of the evaluations comprise a certain weight within the algorithm, and upon considering all data relevant thereto, a decision can be made. In other embodiments, the administrator may accept recommendations from consultants, employees, etc., who have reviewed the athlete's data and/or conducted an evaluation, yet determine whether a player will be accepted or not based upon a random or arbitrary calculation done on an athlete by athlete basis.

Once an athlete is accepted into the system, the athlete may become a system player, such that the athlete is designated and held out to the public as being affiliated with the administrator. In such an embodiment, the administrator effectively becomes a sponsor of the athlete, but beyond mere financial sponsorship, the athlete may be fully committed to the administrator from an across-the-board perspective. In other embodiments, acceptance into the system indicates that the administrator will offer the athlete a job as a contract employee, whereby the administrator will agree to provide certain compensation and benefits, as described herein, in exchange for the athlete's performance, appearances, behavior and the like.

Once in the system, the athlete is exposed to numerous professionals to enable the athlete to reach a maximum skill potential. As such, although the following steps are described in a particular order, no such order may be necessary with any of the steps of the method 700; however, those steps prior to acceptance take place prior to acceptance, and those steps after acceptance only take place after.

At step 735, the athlete engages in mental skill mentoring. In many embodiments, a reason why the athlete is not playing to the maximum potential is due to personal distractions, issues with focus, or the like. During the athlete's time within the system, the athlete may meet with a sport mental skills professional on an ongoing and/or regular basis. In many embodiments, the athlete may discuss certain issues, concerns, etc. with the mental skills professional. In other embodiments, the athlete may learn and/or practice certain drills to learn to maintain proper focus during physical performance. In yet further embodiments, the athlete may just need to check in and have a brief conversation with a mental skills professional from time to time.

At step 740, the athlete engages in life coach mentoring. In many embodiments, the athlete's personal issues interfere with the athlete's ability to perform at its best on a regular basis. For example, for an amateur athlete, while sports competition may be the most important thing on the athlete's mind, the lack of income due to amateur status may cause significant financial issues/concerns. Similarly, if the athlete is having problems with a significant other or family member, there may be significant distraction caused thereby. As such, in many embodiments, the athlete may communicate with a life coach/mentor who can advise the athlete how to resolve or handle such issues. In other embodiments, the life coach/mentor may be able to assist the athlete by providing the athlete a plausible path to attain whatever is needed to lessen the external distractions (e.g., find financial assistance, get spouse in counseling, just listen to the athlete vent about personal problems, etc.)

At step 745, the athlete may optionally engage in skill and/or performance mentoring. In many embodiments, this step comprises using skill coaches to advise and guide the athlete to increase the athlete's physical performance. In many embodiments, the skill or performance mentoring is conducted by a professional in the particular athletic field, and/or has experience in general strength and/or conditioning training. For example, for an athlete golfer, a golf pro may work with the athlete to perfect putting. In another example, for a professional racecar driver, an experienced pit crew boss may work with the athlete to enhance the athlete's perception of when a racecar needs to come in. In yet another example, for a baseball athlete, a pitching/hitting coach may work with the athlete to fix a glitch in a pitch or swing, respectively. In further embodiments, general trainers, such as physical therapists, massage therapists, conditioning trainers, biomechanics coaches or the like may also be utilized to work with the athlete.

At step 750, the administrator enables the fan base forum. In many embodiments, the fan base forum is the crux between training an athlete in general, and enabling embodiments of the present invention to function. Generally, the fan base forum comprises a social media network wherein the administrator enables fans (i.e., any of the secondary users described hereinabove), to directly and indirectly engage the athlete within the system and effectively, power the system's operation.

In one exemplary embodiment, the administrator establishes a social media page, or “storefront” for each of the athletes within the system, and hosts the same on a sever accessible via a network. In order for a fan to access the system, and in particular, a storefront for an athlete, the fan must become an authorized fan of the system. In many embodiments, such authorization comes by way of subscribing to the system, establishing an account and paying an access fee.

In accordance with several embodiments, a fan of the system may have to select a position to which the fan wishes to be designated when subscribing to the system. Such position may comprise a platform or tier within a hierarchy system, and may often be connected to the value of compensation paid by the fan to access the system. For example, in one embodiment, a fan may have either a generic designation for nominal compensation, a first preferred status for a greater compensation, and even a higher preferred status for a significant compensation. As embodiments of the present invention may vary, the amount of compensation required for each level may also vary with each system.

Often, the fan platform or tier within the system often designates the level of accessibility the fan may have within the system. For example, a generic fan may have regular access, a higher tiered fan may have some exclusive events and features, and the highest tiered fan may have unlimited access. Similarly, in many embodiments, for merely subscribing to the system, a fan may receive a token of appreciation, e.g., some form of merchandise, from the administrator. The quality of the token may be dependent upon the fan's tier within the system.

One objective of the fan base forum is to provide a virtual means by which a fan of an athlete can follow, interact (directly or indirectly), or otherwise exchange data with the athlete. From the fan perspective, a fan may be able to post comments, pictures, videos, or other data on the athlete's storefront, as well as conduct other social networking features thereon. A fan may also be able to watch the athlete's performances (live or taped), communicate with the athlete, (through live video chat, web conference calls, or the like), track the athlete's performance statistics, etc.

As introduced above, the tiered approach for fan subscription may allow certain fans to be passive and others more active. For example, a generic fan may be permitted to read and watch postings on the athlete's storefront, a higher tiered fan may be able to post comments, pictures, and other data on the athlete's storefront, and the highest tiered fans may be invited to communicate directly with the athlete through the live chat means, etc.

From an athlete's perspective, the fan base forum comprises a means through which the athlete can communicate with fans, as well as receive support, motivation, and other useful data. As such, as far as mental skill mentoring and life coach mentoring, the positive role played by the fan base forum can assist in creating a more positive outlook in life and in performances, which in turn may assist with overall performance.

Although the method ends at step 755, the method will continue to repeat itself from step 735 to step 750 as long as the athlete is part of the system.

Aside from the general methods of the system, additional components of the system act to benefit all parties involved. For example, by providing a subscription system for fans, the fans themselves act as sponsors or investors in the athletes. For example, a fan may not only subscribe to the system, but to one specific athlete within the system. As such, when the fan provides a payment, a set percentage of that payment may be utilized to benefit the player. For example, for every dollar provided by a fan of an athlete, a small percentage is carved out for the administration of the system, and the remainder of the dollar is provided to an account for the player to pay for travel, room, board, training facilities, equipment, coaches, and the like. The fan may have the option of paying using either cash, credit, valuable assets (e.g., sports equipment, airline miles, coupons, vouchers, etc.), or the like.

One benefit of providing an investor-type structure is the motivation for the fans to continue sponsoring the athletes. As the athletes perform better, the fan feels as though the investment was a successful one, and may continue to do so. In addition, as the athlete performs better, and perhaps no longer needs the system, the fan may choose to continue investing in athletes to create more successes.

In another embodiment, as further incentive for fans to contribute more and become a higher tiered status, the administrator may facilitate high profile events, such as annual galas, celebrity meet and greets, etc., whereby fans of higher tiers are able to come and meet the athletes. Optionally, the administrator may make such events accessible to all fans, yet provide free access to the top tier. In other embodiments, personalized meetings between fans and athletes, and perhaps between other fans, may be facilitated by the administrator to create greater interest in further involvement within the system.

It should be appreciated by other embodiments of the present invention, although most of what is described herein is directed to athletes, equally competitive fields may utilize these methods as well. For example, any performing arts fields, such as actors, musicians, writers, etc., may find such a developmental program beneficial. As such, alternative embodiments of the present invention should be deemed equally supportive of those industries as well.

While the foregoing is directed to exemplary embodiments of the present invention, other and further embodiments of the invention may be devised without departing from the basic scope thereof, and should be considered part of this disclosure, as if described fully herein. Specifically, whereas the worldwide web and mobile web are growing content and capabilities at ever-increasing rates, the ability to adapt the systems, methods, applications, and interfaces disclosed herein to existing or new mobile- or web-based technology is contemplated by embodiments of the present invention and does not depart the scope of the invention disclosed herein.

What is claimed is:

1. A computer-implemented method for utilizing an athlete development system, the method comprising:
at a computing device hosted by an administrator, the computing device having a processor and a memory for storing a set of instructions for execution by the processor, the instructions for enabling a method comprising:
receiving an application to access the system from an athlete and storing the application in an athlete database;
conducting an athlete evaluation, the athlete evaluation comprising at least one of a mental skills assessment of the athlete, an assessment of past performance of the athlete, or an evaluation of the marketability of the athlete;
allowing an administrator to grant access to the system to the athlete based on the results of the athlete evaluation and the application;
enabling a mentoring module for the athlete, the mentoring module comprising at least one of mental skill mentoring or life coach mentoring; and
enabling a fan base forum module adapted to enable a fan to engage the athlete within the system.

2. The method of claim 1, wherein the mentoring module further comprises skill and performance mentoring.

3. The method of claim 2, wherein the skill and performance mentoring comprises allowing a training professional to communicate with the athlete and provide mentoring to the athlete regarding the athlete's physical performance.

4. The method of claim 1, wherein the application comprises at least one of biographical information of the athlete, the biographical information comprising at least one of the age of the athlete, the weight of the athlete, the height of the athlete, performance results of the athlete, organizations with which the athlete is affiliated, the ethnicity of the athlete, or a disability of the athlete.

5. The method of claim 1, wherein the mental skills assessment comprises:
administering a mental skills assessment to the athlete; and
enabling the administrator to communicate with a mental health professional to evaluate the results of the mental skills assessment.

6. The method of claim 5, wherein the mental skills assessment comprises at least one of a computerized testing procedure or a clinical interview of the athlete conducted via the system.

7. The method of claim 1, wherein the assessment of past performance comprises allowing an administrator to review at least one of a finishing position of an athlete, a final score of a sporting event the athlete participated in, a set of sporting statistics of the athlete, performance trends of the athlete, or results of the athlete's performance under situations designated as high pressure by the administrator.

8. The method of claim 1, wherein the evaluation of the marketability of the athlete comprises allowing an administrator to review at least one of the affiliations of an athlete, a disability of an athlete, a personality assessment of the athlete, an ethnicity of an athlete, or third party surveys assessing the marketability of the athlete.

9. The method of claim 1, wherein the athlete evaluation further comprises:
calculating a weighted evaluation score based on the results of the mental skills assessment, the assessment of past performance, and the evaluation of marketability; and
providing the weighted evaluation score to the administrator.

10. The method of claim 1, further comprising allowing the administrator to provide financial resources to the athlete via the system.

11. The method of claim 1, wherein the mental skill mentoring comprises allowing a mental skills professional to communicate with the athlete and provide mental skill mentoring via the system.

12. The method of claim 1, wherein the life coach mentoring comprises providing the athlete educational materials regarding personal finances and allowing a life coach to communicate with the athlete to provide life coach mentoring.

13. The method of claim 1, further comprising:
enabling the administrator to authorize the fan to use the fan forum module; and
enabling the administrator to designate a status level to the fan, the status level comprising at least a general status and a preferred status.

14. The method of claim 12, wherein the fan forum module may be adapted to allow a fan with general status to access general information about the athlete, to allow a fan with preferred status to communicate directly with the athlete via the system.

15. The method of claim 1, wherein the fan forum module may be adapted to allow a fan to engage with an athlete if the fan has paid a subscription fee.

16. A computer-implemented method for utilizing an athlete development system, the method comprising:
at a computing device hosted by an administrator, the computing device having a processor and a memory for storing a set of instructions for execution by the processor, the instructions for enabling a method comprising:
receiving an application to access the system from an athlete and storing the application in an athlete database;
conducting an athlete evaluation, the athlete evaluation comprising at least one of a mental skills assessment of the athlete, an assessment of past performance of the athlete, or an evaluation of the marketability of the athlete;
allowing an administrator to grant access to the system to the athlete based on the results of the athlete evaluation and the application;
enabling a mentoring module for the athlete, the mentoring module comprising at least one of mental skill mentoring or life coach mentoring;
enabling a fan base forum module adapted to enable a fan to engage the athlete within the system; and
enabling the administrator to designate a status level to the fan, the status level comprising at least a general status and a preferred status;
wherein the fan forum module may be adapted to allow a fan with general status to access general information about the athlete, to allow a fan with preferred status to communicate directly with the athlete via the system.

17. The method of claim 16, wherein the fan forum module may be adapted to allow a fan to engage with an athlete if the fan has paid a subscription fee.

18. The method of claim 16, further comprising allowing the administrator to provide financial resources to the athlete via the system.

19. A computer-implemented athlete fan forum module comprising:
at a computing device hosted by an administrator, the computing device having a processor and a memory for storing a set of instructions for execution by the processor, the instructions for enabling a method comprising:
allowing the administrator to grant access to a system to an athlete;
enabling a fan base forum module adapted to enable a fan to engage the athlete within the system; and
enabling the administrator to designate a status level to the fan, the status level comprising at least a general status and a preferred status;
wherein the fan forum module may be adapted to allow a fan with general status to access general information about the athlete, to allow a fan with preferred status to communicate directly with the athlete via the system; and
wherein the fan forum module may be adapted to allow a fan to engage with an athlete if the fan has paid a subscription fee.

20. The fan forum module of claim 19, permitting the administrator to provide financial resources to the athlete via the system based upon an amount of the subscription fee.
